(19) United States
(12) Patent Application Publication
(10) Pub. No.: US 2011/0047213 A1
(43) Pub. Date: Feb. 24, 2011

(54) Method and process for identifying trusted information of interest

(76) Inventor: Alan David Manuel, San Francisco, CA (US)

Correspondence Address: Alan D. Manuel, 440 27th Street, San Francisco, CA, 94131, US

(21) Appl. No.: 12/583,394

(22) Filed: Aug. 20, 2009

(51) Int. Cl. G06F 15/16

(52) U.S. Cl. 709/204

(57) ABSTRACT

A method and process for identifying trusted information of interest consisting of: (1) optionally, accepting as input from a user (a “requester”) a demand for recommendations; (2) determining a set of users (“participants”) eligible to provide, receive, and evaluate recommendations; (3) accepting as input from participants recommendations and indications of concurrence of opinion on recommendations; (4) determining the level of trust that a user has in participants, their recommendations, and their indications of concurrence of opinion on recommendations; (5) presenting recommendations and indications of concurrence of opinion on recommendations to a user contemporaneously with a predicted level of trust in recommendations; and (6) repeating steps 1-5.

### CROSS REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of the Invention

The present invention relates to the field of information systems, and more specifically to computer-based information systems used to identify trusted information of interest.

2. Background of the Invention

Today, individuals and organizations have access to information systems and technologies which provide information on an unprecedented scale, offering the possibility of a more informed, more engaged, more satisfied populace. Once an individual has identified an interest, he or she can use such information systems and technologies to perform research, read opinions, exchange ideas, and share experiences on nearly any imaginable topic. Yet the ever increasing availability of such systems and technologies has given rise to another problem.

Individuals and organizations cannot effectively perform primary identification of interests outside domains encompassed by their personal knowledge and experience, and cannot efficiently filter information at the scale and level of detail at which it is provided. This problem arises because individuals and organizations lack a convenient, practical method to identify trusted information of interest. As a result, individuals and organizations continue to consume information in limited quantities, in a limited set of domains, and from a limited set of known sources, Such behavior negates the benefits that increased availability of information systems and technologies could provide. The lack of a convenient, practical method for identifying trusted information of interest is limiting the ability of information systems and technologies to enhance and improve people's lives.

Trusted information of interest refers to information of interest provided to an individual or organization (a “recipient”) and identified by at least one individual or organization (a “source”) whose opinions the recipient trusts as being appropriate. The need for a convenient, practical method to identify trusted information of interest spans many domains, including individuals and organizations who: (a) wish to perform research on, consume, or produce, goods or services, of any sort, (b) wish to engage socially with others who have similar tastes, (c) are considering products, services, business concepts, suppliers, customers, or business partners, (d) are seeking guidance in forming opinions in the arts, sciences, law, fashion, entertainment, politics, religion, or other areas, (e) are seeking inspiration in developing new interests, (f) are faced with multiple selection opportunities where trusted guidance is valuable, and other domains. A convenient, practical method for identifying trusted information of interest would greatly improve the ability of individuals and organizations to realize the benefits that increasing availability of information systems and technologies could provide.

An ideal method for identifying trusted information of interest would provide relevant, timely, comprehensive recommendations:

First, an ideal method for identifying trusted information of interest would provide relevant recommendations. That is, an ideal method for identifying trusted information of interest would present a user with recommendations that are most likely to be useful to the user by appropriately taking into account the quality and quantity of the user's relationships (including trust relationships, social relationships, organizational relationships, and other types of relationships) with sources of recommendations. Additionally, such a method would improve a user's trust in recommendations over time by improving the quality and quantity of each user's relationships with actual and potential sources of recommendations.

Second, an ideal method for identifying trusted information of interest would provide timely recommendations. That is, an ideal method for identifying trusted information of interest would provide recommendations whenever a user is receptive to new recommendations, either upon request or upon the occurrence of an event of interest to the user, at the right frequency and volume.

Finally, an ideal method for identifying trusted information of interest would provide comprehensive recommendations. That is, an ideal method for identifying trusted information of interest would provide recommendations on any topic, including topics for which a user has not requested recommendations and topics in which a user has no prior knowledge or previously expressed interest. Such a method would take input from a broad array of sources, such as subject matter experts, enthusiasts, sources outside of a user's personal, social, professional, academic, or other networks, and other sources unrelated to the user. An ideal means for identifying trusted information of interest would additionally stimulate the development of new interests for a user.

Conventional systems and methods for identifying trusted information of interest do not provide relevant, timely, comprehensive recommendations. Conventional systems and methods for identifying trusted information of interest suffer from a number of disadvantages and limitations, including, but not limited to, the following:

Conventional systems and methods typically lack a convenient, practical means for a user to determine which recommendations to trust. Where such a means is provided, there is typically no way for a user to verify and correct assumptions made in determining which recommendations to trust.

Conventional systems and methods typically lack a means to allow a first user to establish and maintain a relationship with a source of a recommendation, and with other users who have indicated concurrence of opinion on the recommendation, such relationships characterized by indications of the level of trust the first user has in recommendations provided by the source and by the other users. Such systems and methods therefore cannot properly take into account relationships among users when determining the level of trust a user should have in a recommendation. Such a lack limits the relevance of recommendations provided by such methods.

Conventional systems and methods typically lack a means to explicitly present to a user the user's relationships with sources and recipients of recommendations, such presentation comprising indications of the level of trust the user has in recommendations provided from a source or to a recipient. Such a lack reduces a user's trust in recommendations and limits the possibility for improved social interaction among the user and sources and recipients of recommendations.

Conventional systems and methods typically lack a means to improve the quality and quantity of provided recommendations over time by improving the quality and quantity of a user's relationships with sources and recipients of recommendations. Conventional systems and methods typically lack a means for a first user to set explicitly and refine the level of trust the first user has in recommendations from a second user based on concurrence of opinion between the first user and the second user. Such shortcomings reduce the relevance of recommendations provided by such systems and methods.

Conventional systems and methods typically lack a means to provide recommendations both in response to a user's request for recommendations and spontaneously upon the occurrence of an event of interest to the user. Such a lack limits the timeliness of recommendations provided by such systems and methods.

Certain conventional systems and methods lack a means to provide recommendations to a first user if such a recommendation is outside the established pattern of behavior or interest of the first user and of other users closely related to the first user. Conventional systems and methods typically lack a means to provide recommendations to a user in a topic of which a user has no prior knowledge or in which a user has not previously expressed interest. Such a lack limits the ability of such systems and methods to stimulate the development of new interests for a user. Such disadvantages limit the comprehensiveness of recommendations provided by such systems and methods.

Certain conventional systems and methods lack a means to differentiate levels of trust that a user has in recommendations provided by sources of recommendations, incorrectly presuming that all such recommendations have the same relevance to the user, and that the user has the same level of trust in recommendations provided by all such sources. Certain conventional systems and methods lack a means to determine eligibility of a first user to provide recommendations to a second user and, by default, allow any first user to provide recommendations to any second user. Such disadvantages reduce the appropriateness of recommendations and limit the relevance of recommendations provided by such systems and methods.

Certain conventional systems and methods assume that the more closely related two users are socially (e.g., the fewer “degrees of separation” between two users in a social network), the greater the level of trust each such user has in recommendations provided by each other such user. In fact, levels of trust are not always correlated in this manner. Two users may be closely related socially (such as both having attended the same school at the same time) and have low levels of trust in recommendations provided by each other, while two users whose levels of trust in recommendations provided by each other are high may not be closely related socially. Such an assumption reduces the relevance of recommendations provided by such systems and methods. Further, such an assumption limits the possibility of discovering new relationships between two users by identifying concurrence of opinion between such two users. Even further, such an assumption limits the ability of such systems and methods to identify new relationships where no such relationships could otherwise be determined.

Certain conventional systems and methods assume that correlation of behavior among two or more users implies ability for each one of such two or more users to influence each other. Such systems and methods assume that any two users who have expressed similar behavior are well suited to make recommendations to one another. In reality, even though two users may have expressed similar behavior, one of such users may be more trusted as a source of recommendations, while a different one of such users may more commonly be a recipient of recommendations and not be trusted as a source of recommendations. Or, both such users may commonly be recipients of recommendations from a third user. Such an assumption reduces the relevance of recommendations provided by such systems and methods.

Conventional systems and methods typically lack a means for a first user to judge credibly the extent to which a second user is considered a subject matter expert. Such typically provided mechanisms as a user profile, an indication of the number of comments a second user has made, the length of time a second user has been active, and other similar mechanisms, are not reliable indicators of subject matter expertise for a first user. Certain conventional systems and methods lack a means to allow individual users explicitly to make recommendations. According to such systems and methods, it is impossible for a subject matter expert explicitly to provide recommendations. Certain conventional systems and methods provide recommendations anonymously, and lack a means for a recipient user to judge the level of trust she should have in such recommendations. Such disadvantages limit the relevance and comprehensiveness of recommendations provided by such systems and methods.

Certain conventional systems and methods provide an overabundance of recommendations based on relationships which have little practical value. Certain conventional systems and methods provide recommendations based on relationship information which is out of date. Such systems and methods lack a means to automatically update relationship values based on the passage of time. Such disadvantages limit the relevance of recommendations provided by such systems and methods.

Certain conventional systems and methods lack a means for providing recommendations outside the context of specific types of domains, such as domains where a user's behavior can be tracked, domains where a useful, common decomposition model exists for specifying demand for and supply of recommendations, and other types of domains. Such a lack limits the comprehensiveness of recommendations provided by such systems and methods.

As can be seen from a review of the current state of the art, no conventional system or method overcomes all of the above mentioned, plus other, disadvantages. No system and method exists today which provides relevant, timely, comprehensive recommendations as a means for identifying trusted information of interest.

### OBJECTS AND ADVANTAGES

The present invention relates to systems and methods for identifying trusted information of interest. The present invention overcomes disadvantages of conventional systems and methods with objects and advantages, including, but not limited to, the following.

In one aspect, the present invention identifies trusted information of interest by providing a user with recommendations that are relevant (that is, most likely to be useful to a user, taking into account the user's relationships with sources of recommendations, stimulating the development of new interests, and improving the quality and quantity of a user's relationships with sources of recommendations), timely (that is, provided whenever a user is most receptive to new recommendations, either upon request or upon the occurrence of an event of interest to the user), and comprehensive (that is, on any topic, including topics for which a user has no prior knowledge or previously expressed interest, taking input from a broad array of sources including, but not limited to, subject matter experts, enthusiasts, and sources outside of a user's personal, social, professional, academic, or other networks, and other sources unrelated to a user).

Advantageously, the present invention comprises a convenient, practical means to determine which recommendations to trust. The present invention provides a means to determine the level of trust that a first user has in recommendations from a second user. Further, the present invention provides a means for a user to verify and adjust assumptions made in determining levels of trust. The present invention presents recommendations with an indication of a predicted level of trust a user should have in such recommendations as a means to inform and assure the user of the relevance of the recommended information of interest. The present invention further comprises a means for a user to recommend trusted information of interest, by which means a user is able to indicate concurrence of opinion with recommendations. According to the present invention, such indications are used to optimize the determination of which recommendations to trust.

Advantageously, when determining which recommendations a user should trust, the present invention takes into account the user's relationships with user sources of recommendations by maintaining a network (a “trust network”) of users with relationships between users characterized by indications (“relationship values”) of the level of trust a first user in a relationship has in recommendations provided by a second user in the relationship. A set of relationship values is used in determining the level of trust a user has in recommendations. A set of relationship values is additionally used in controlling the volume and frequency of recommendations received by a user. Relationship values may have one or more dimensions. For example, in one embodiment, a multi-dimensional relationship value may indicate a level of trust, a time period over which such level of trust is valid, and the conditions under which such level of trust is valid.

In one embodiment of the present invention, recommendations from a first user to a second user are presented to the second user contemporaneously with an indication of the level of trust the second user has in recommendations from the first user. Such presentation improves ability of the second user to evaluate a recommendation from the first user. Additionally, such presentation comprises a means for the second user to inspect, verify, adjust, and set explicitly such indications, which in turn improves the quality and quantity of recommendations. Further, such presentation improves social interaction between the first user and the second user by providing increased transparency of levels of trust the first user has in recommendations from the second user.

Advantageously, the present invention provides recommendations both in response to user requests as well as spontaneously, upon the occurrence of an event of interest to a user.

Advantageously, the scope of recommendations provided by the current invention encompasses any domain. The present invention provides recommendations to a first user even if such recommendations are outside the prior knowledge and previously expressed interest of the first user and of users closely related to the first user. Recommendations are provided in domains for which useful decomposition models for specifying supply of and demand for recommendations do not exist.

Advantageously, the present invention provides a means for improving a user's trust in recommendations over time by improving the quality and quantity of a user's relationships with sources of recommendations based on the user's concurrence of opinion with recommendations, and other factors.

In one embodiment of the present invention, a trust network provides an improved means for determining the level of trust that a first user has in recommendations versus assuming that the first user has the same level of trust in all sources of recommendations, and versus assuming that the first user is more likely to trust recommendations from a second user who is closely related socially, and versus determining trust in recommendations using another means not comprising a measure of the ability of a second user to provide trusted information of interest to a first user.

The present invention provides a beneficial outcome not envisaged in the prior art. Providing a means for a user to indicate concurrence of opinion with recommendations provided by the present invention improves the quality of the trust network. And simultaneously, improvements in the quality of the trust network improve the quantity and quality of recommendations provided by the present invention. In the preferred embodiment of the present invention, recommendations for a first user are selected, prioritized and presented based, in part, on the level of trust a first user has in recommendations provided by sources of recommendations, while a first user's indications of concurrence of opinion with recommendations further refine levels of trust the first user has in sources of recommendations. Further, a first user's indications of concurrence of opinion with recommendations further refine levels of trust the first user has in other user recipients, not the source, of such recommendations. The present invention provides a further beneficial outcome, the creation of a more compelling basis for social interaction among users by establishing tangible points of concurrence of opinion among such users.

The present invention provides a further beneficial outcome not envisaged in the prior art. According to the present invention, a new relationship for a first user may be spontaneously created, where no such relationship could otherwise be determined, as a result of the first user indicating concurrence of opinion with a recommendation. Further, such spontaneous creation of a new relationship requires no additional effort on the part of a user, and such relationships have a more meaningful basis for existence (i.e., concurrence of opinion) than a typical social relationship. The ability for spontaneous creation of new relationships overcomes a deficiency of certain conventional systems and methods which require a user explicitly to establish relationships in order to provide or receive recommendations, or which determine potential new relationships based on interpreting existing relationship information.

Advantageously, the present invention allows subject matter experts explicitly to provide recommendations and importantly, provides a credible means for a recipient user to judge the extent to which a source user is a subject matter expert.

The present invention overcomes a disadvantage of certain conventional systems and methods which is the overabundance of relationships that have limited practical value. As opposed to such conventional systems and methods, the present invention provides a means for ensuring that relationships have significant practical value by: (1) keeping track of the level of trust a first user in a relationship has in recommendations provided by a second user in the relationship, (2) presenting such level of trust to the first user, at least in the context of managing relationships with, and considering recommendations from, the second user, (3) using such level of trust to control the manner in which recommendations and requests for recommendations are processed, and (4) allowing a user to set explicitly such levels of trust for a relationship.

The present invention overcomes a further disadvantage of certain conventional systems and methods which provide recommendations based on relationship information which is out of date. In contrast with such systems, the present invention automatically modifies the effect of relationship values over time without explicit action by a user. According to the current invention, for the purposes of determining a first user's level of trust in a recommendation, the first user's relative trust in a second user changes over time despite a lack of activity on the part of the first user with regard to the second user. In such a manner, the current invention more closely models human relationships, which may change over time due to a lack of common activity.

The present invention more accurately models a user's desire to associate with other like-minded users and provides an improved representation of relationship value. Unlike certain conventional systems and methods, the present invention enables a user to provide to and receive recommendations from other users in the absence of pre-existing social relationships with such other users. Advantageously, the present invention determines ability for a first user to influence a second user independently of a social relationship, if any, between the first user and the second user.

The present invention improves the quantity and quality of recommendations a user receives by providing an improved means for managing eligibility of sources to provide recommendations. According to the present invention, requests for recommendations from a first user are automatically directed to appropriate user sources of recommendations, such direction determined in part by levels of trust a first user has in such sources (including potentially sources not personally known to the first user). Additionally, recommendations associated with events of interest to a first user are automatically directed to the first user from user sources contemporaneously with indications of the level of trust the first user has in recommendations from such sources, such direction determined in part by levels of trust the first user has in recommendations provided by such sources (including potentially sources not personally known to the first user).

The present invention improves the quantity and quality of recommendations a user receives by providing an improved means for distributing recommendations. According to the present invention, for each recommendation from a source user for an intended recipient user, the system automatically determines, using as a criterion the level of trust that a potential additional recipient user has in recommendations provided by the source user, a set of one or a plurality of additional recipient users (comprising potentially recipient users not personally known to the source user) in addition to originally intended recipient user(s). The system provides recommendations to the additional recipient user(s) without additional effort from the source user, thus improving the quantity of recommendations provided by the system. Further, the system provides recommendations to additional recipient user(s) even if no originally intended user recipient is specified.

In one aspect of the present invention, a trust network is characterized by participation of users in topics. Participation of a user in a topic establishes eligibility of the user to provide recommendations within the context of the topic to other user participants in the topic, to receive recommendations from other user participants within the topic, and to indicate concurrence of opinion on recommendations provided within the context of the topic by other user participants in the topic. Participation of users in topics improves the quantity and quality of recommendations provided by the current invention by establishing, for any two user participants in a topic who would not otherwise be related and who have not yet indicated concurrence of opinion on the same recommendation, default relationships between the two users indicating greater concurrence of opinion between the two users versus two otherwise similar users who are not both participants in the same topic.

Participation of users in topics improves the management of eligibility of potential source users to provide recommendations by establishing participation of a user in a topic as a requirement in order for a potential source user to be eligible to provide recommendations to topic participants. Participation of users in topics further improves the distribution of recommendations by establishing participation of a user in a topic as a requirement in order for the user to be eligible to receive recommendations within the context of the topic.

Advantageously, participation of users in topics establishes a community of interest in a topic whose members are participants in the topic. Establishment of communities of interest provides at least two benefits. First, such communities of interest foster social interaction among members, confirming and enriching pre-existing social relationships, and providing a basis for the establishment of new social relationships. Second, communities of interest limit the scope of calculations required to determine levels of trust, reducing the computational processing required to make determinations of trust and improving the accuracy of such calculations.

The computer implemented method of the present invention provides a convenient, practical means to identify trusted information of interest, such means comprising the following steps: (1) optionally, accepting as input from a user (a “requester”) a demand for recommendations; (2) determining a set of users (“participants”) eligible to provide and evaluate recommendations; (3) accepting as input from participants recommendations and indications of concurrence of opinion on recommendations; (4) determining the level of trust that a user has in participants, their recommendations, and their indications of concurrence of opinion on recommendations; (5) presenting recommendations and indications of concurrence of opinion on recommendations to a user contemporaneously with a predicted level of trust in recommendations; and (6) repeating steps 1-5.

In one aspect, the present invention comprises a computer readable medium, such as, for example, an optical or magnetic data storage device, having stored thereon software for implementing the methods of the invention.

In short, the present invention identifies trusted information of interest by providing relevant, timely, comprehensive recommendations. The computer systems and computer implemented methods of the present invention overcome the above described and other disadvantages of conventional systems and methods.

The above and other features and advantages of the present invention, as well as the structure and operation of the preferred embodiments of the present invention, are described below with reference to the accompanying drawings.

### SUMMARY

In accordance with the present invention, a method and process for identifying trusted information of interest comprises a means for managing eligibility of a user to recommend trusted information of interest, a means for a user to recommend trusted information of interest, and a means to determine the level of trust a user has in recommended information of interest, whereby said method and process provides relevant, timely, comprehensive recommendations.

### DRAWINGS

### Figures

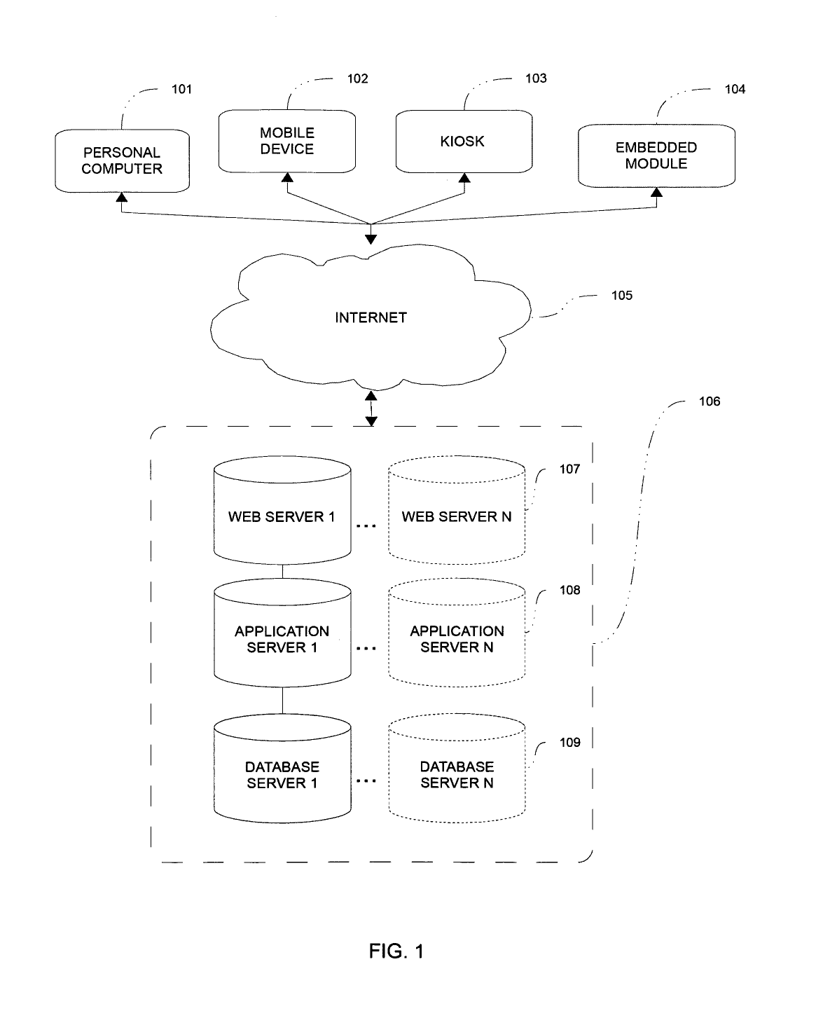

FIG. 1 describes an example system architecture.

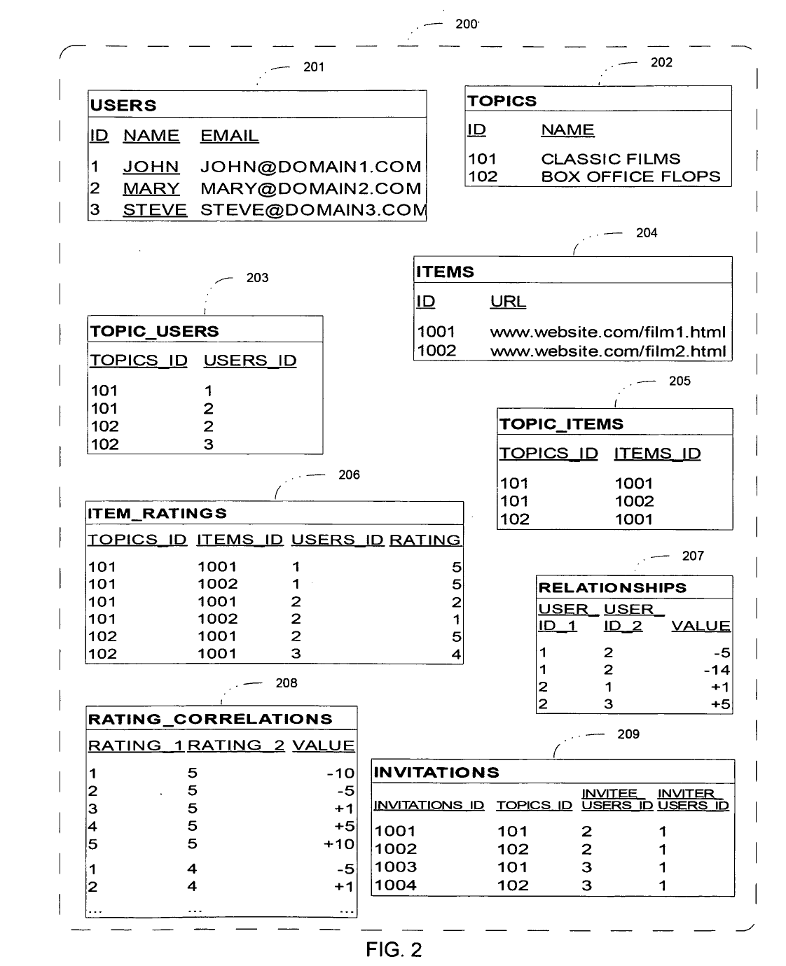

FIG. 2 describes an example database design.

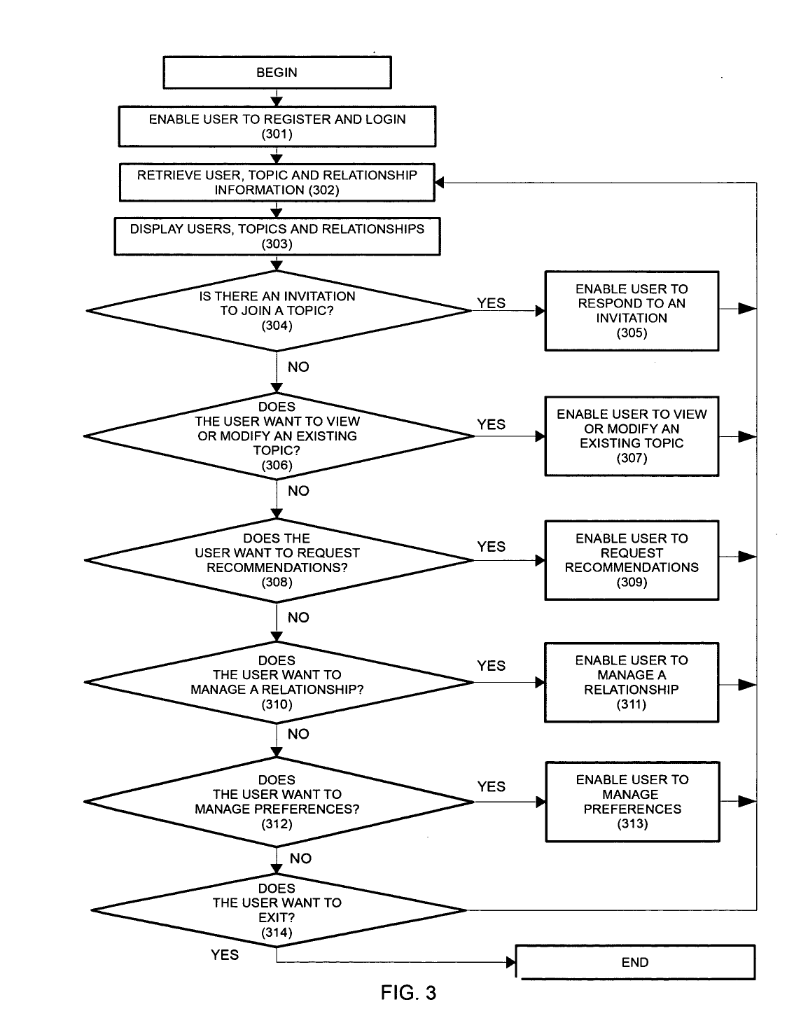

FIG. 3 describes a process overview of the preferred embodiment of the present invention.

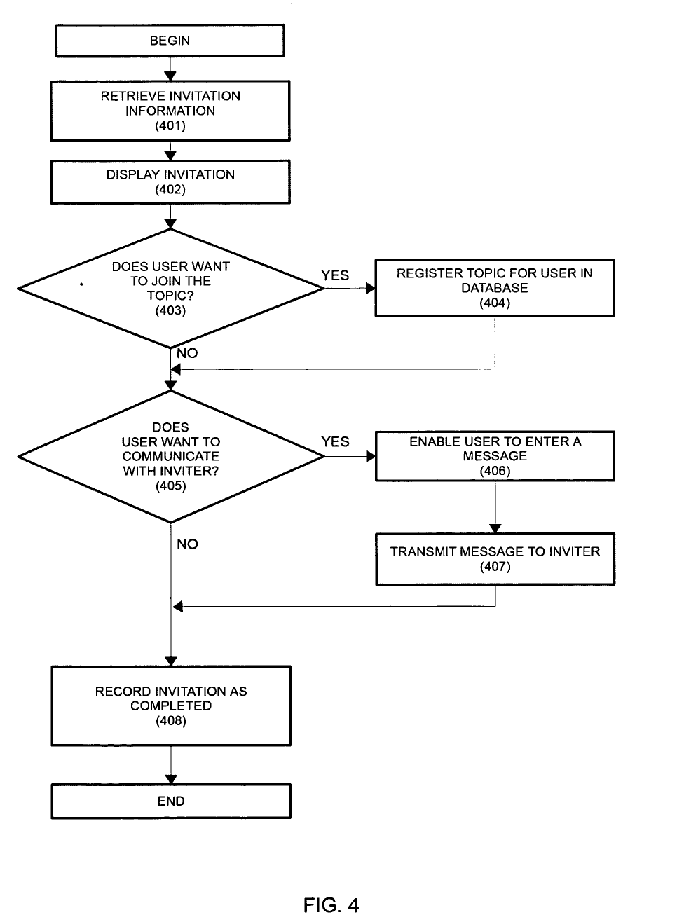

FIG. 4 describes a process to enable a user to respond to invitations.

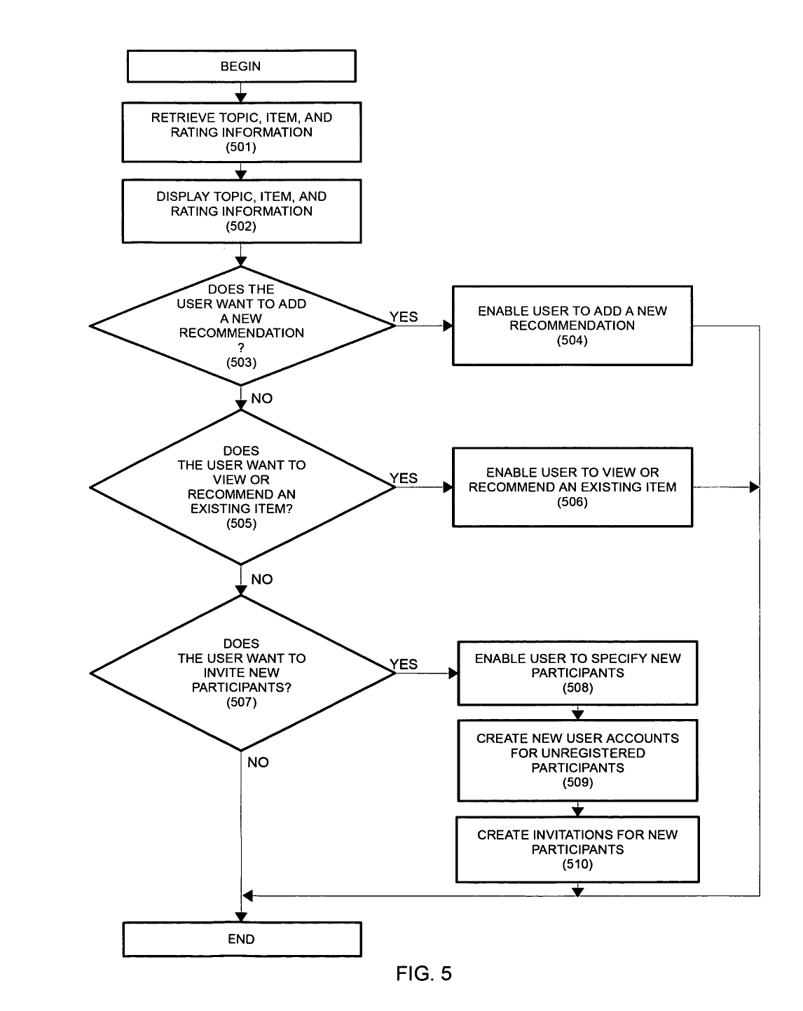

FIG. 5 describes a process to enable a user to view or modify an existing topic.

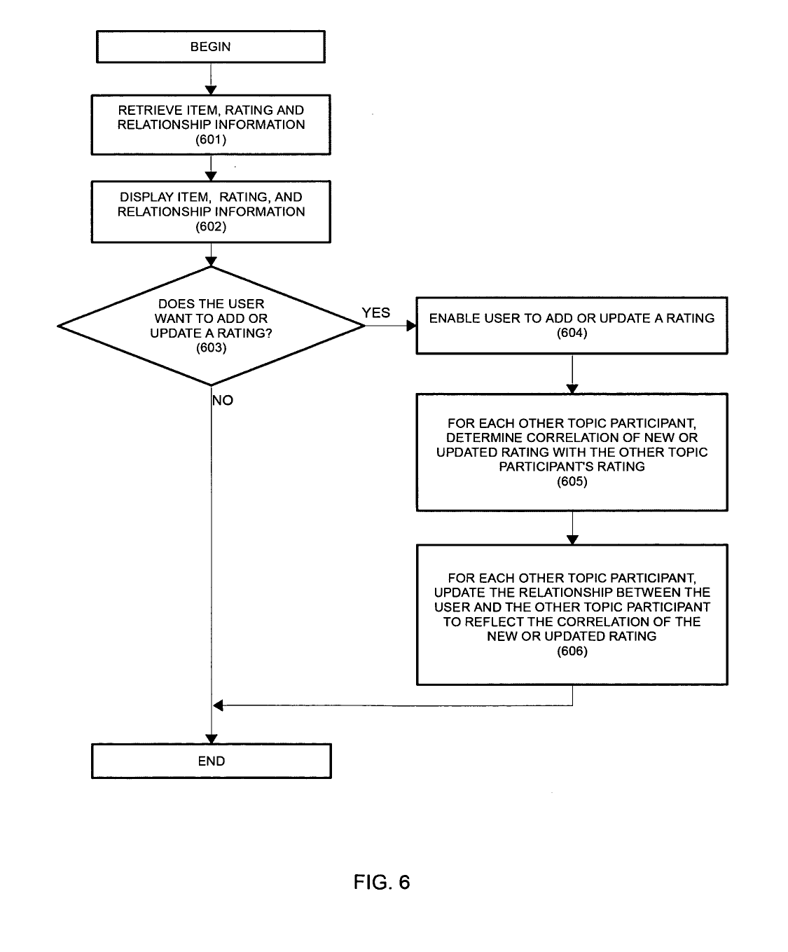

FIG. 6 describes a process to enable a user to view or recommend an existing item.

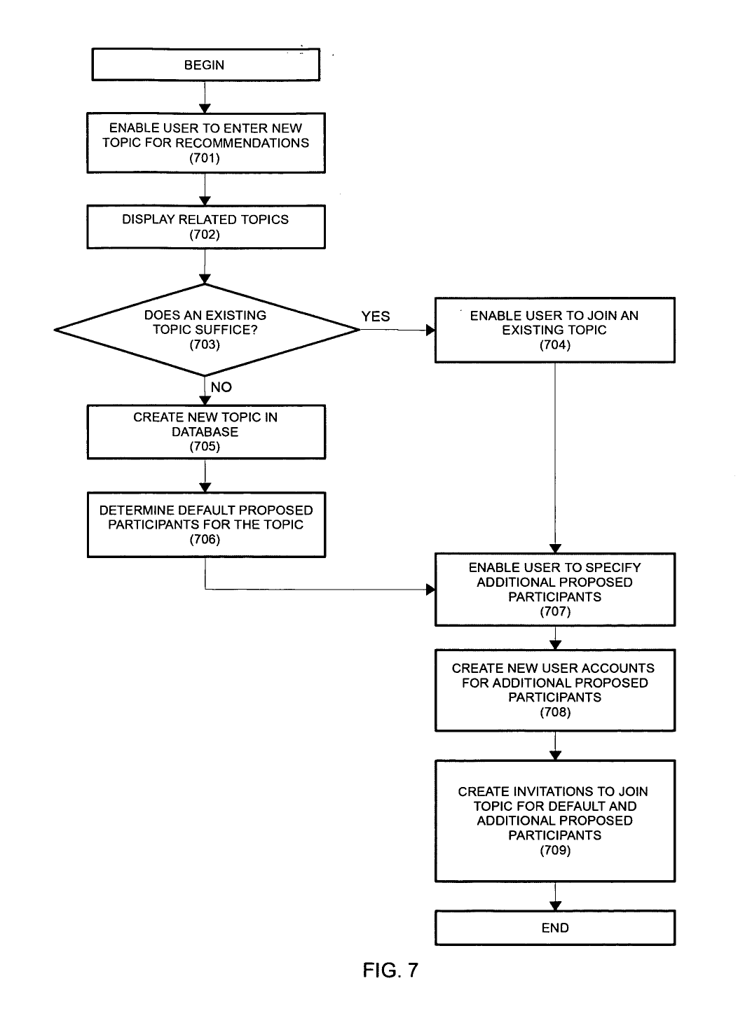

FIG. 7 describes a process to enable a user to request recommendations.

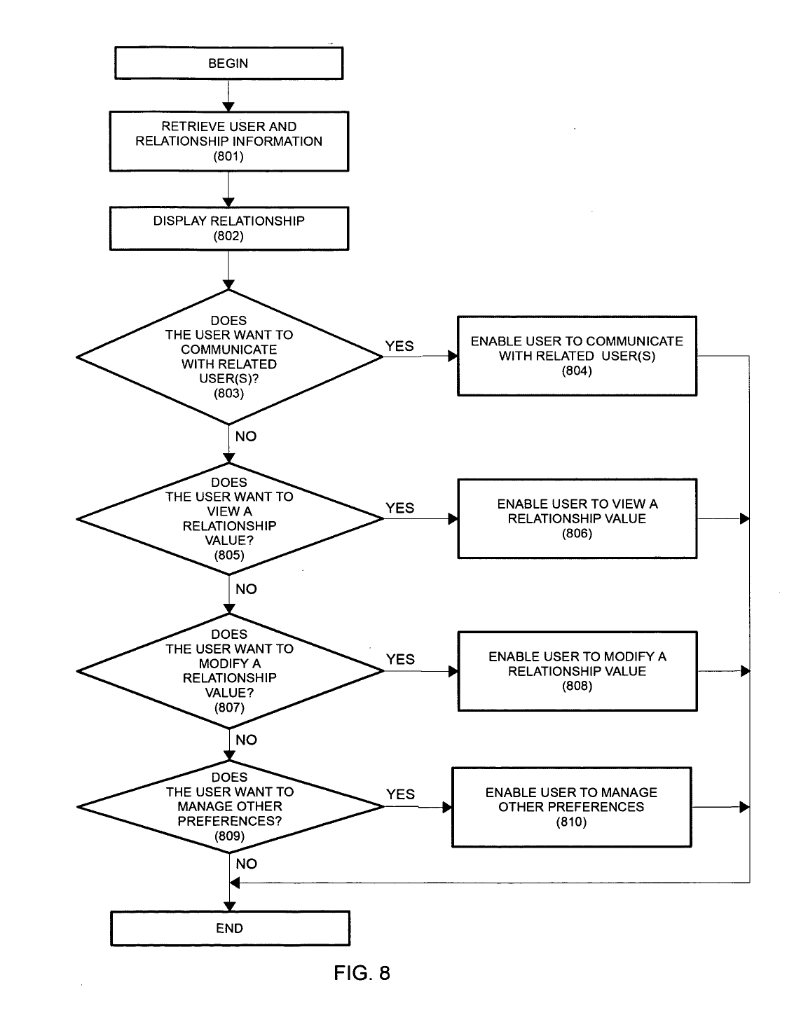

FIG. 8 describes a process to enable a user to manage a relationship.

### DETAILED DESCRIPTION

### FIGS. 1-2

FIG. 1 describes the general architecture of a system that operates in accordance with one embodiment of the present invention. Referring to FIG. 1, a plurality of user interface methods 101, 102, 103, and 104 is connected to a communications network such as the Internet 105. User interface methods may include devices and electronic modules capable of presenting information and optionally accepting user input, and include, but are not limited to, personal computers, mobile telecommunications devices (including mobile telephones and personal digital assistants), kiosks, and embedded electronic modules. Such user interface methods may include other methods not envisaged but which serve a similar purpose. The term “Internet” refers in general to a collection of distinct communications networks working in concert to function as a single network to a user. Although the description may refer to terms commonly used in describing particular public networks such as the Internet, the description and concepts apply equally to other private and public computer networks including wireless wide area networks and systems having architectures dissimilar to that shown in FIG. 1.

Further referring to FIG. 1, an apparatus 106 is connected to the Internet 105. Such connection may be enabled through a combination of components which serves to ensure an efficient, reliable, secure connection. In the interests of clarity, these routine components are not shown or described, but would be obvious to one skilled in the relevant art(s). Components appearing in an apparatus 106 refer to an exemplary combination of components that would need to be assembled in order to provide functions and services contemplated by the present invention. Certain components necessary for the operation of apparatus 106 are omitted for the sake of clarity but would be obvious to one skilled in the relevant art(s). Components comprised within an apparatus 106 may be connected and may communicate via a network or other communications medium. An apparatus 106 may include one or a plurality of central processing units (CPUs), one or a plurality of random access memories (RAM) temporary storage of information, one or a plurality of read only memories (ROM) permanent stores of information, and one or a plurality of semi-permanent stores of information such as hard drives(s).

Still referring to FIG. 1, an apparatus 106 may include a web server 107 or a plurality of web servers 107, an application server 108 or a plurality of application servers 108, and a database server 109 or a plurality of database servers 109. A web server 107 transmits information via the Internet 105 to one or a plurality of interface devices 101, 102, 103, and 104 in response to information requests from one or a plurality of interface devices 101, 102, 103, and 104, and spontaneously upon the occurrence of an event of interest to a user. Information sent from a web server 107 may be configured using certain communications protocols and data format standards, such as Hypertext Transport Protocol (HTTP), Hypertext Markup Language (HTML), Extensible Markup Language (XML), or other contemporary communications protocols and data formats. Information may be interpreted by various software programs running on interface devices for eventual presentation to a human user, or for further use by other, non-human agents such as software programs and electronic devices.

Further referring to FIG. 1, an application server 108 stores and executes computer instructions necessary for the functioning of an apparatus 106. An application server 108 optionally receives information requests from a web server 107, executes computer instructions, requests information from one or a plurality of databases stored on a database server 109, processes information retrieved from a database server 109, and transmits results to a web server 107. A database server 109 stores software, descriptive data, system data, and any other data item required by other components of an apparatus 106. Databases may be provided, for example, as a relational database management system (RDBMS), an object-oriented database management system (OODBMS), a file system, or other conventional database system. Databases on a database server 109 can be accessed via structured query language (SQL) or other tools known to one of ordinary skill in the art.

Still referring to FIG. 1, alternative system architectures may be constructed to perform functions and services as contemplated by the present invention. Such alternative architectures may comprise disparate and distributed components which, working together, serve a substantially similar function as the example system architecture provided in FIG. 1.

FIG. 2 describes an example of one implementation of a database 200 in accordance with one embodiment of the present invention. A database may be provided, for example, as a relational database management system (RDBMS), an object-oriented database management system (OODBMS), a file system, or other conventional database system. Several categories of information are shown in the preferred embodiment of a database 200. The categories include user data, topic data, item data, rating data, rating correlation data, relationship data, and invitation data. While important characteristics of each type of data are disclosed, other characteristics, including certain technical characteristics necessary for the functioning of a computer system to implement the present invention, are omitted for the purposes of clarity, but would be obvious to one skilled in the relevant art(s).

Further referring to FIG. 2, USERS data 201 describe users of the system independently of their interests and relationships. USERS data 201 include, for each user of the system, a unique identifier (ID) for each user, and a unique, human readable name (NAME). USERS data 201 may contain other administrative fields (such as a password) which are omitted for the purposes of clarity, but which would be obvious to one skilled in the relevant art(s). In other embodiments, a user is a group of individuals or an organization. TOPICS data 202 describe summary information about a topic of interest. In the disclosed embodiment of the present invention, a topic refers to a group of zero or more recommendations on a particular subject combined with a set of users (“participants”) interested in the subject. TOPICS data 202 comprise a unique identifier (ID) for each topic and a human readable name (NAME) describing the subject of each topic.

Further referring to FIG. 2, TOPIC_USERS data 203 describe an association of users with topics. In the disclosed embodiment of the present invention, an association of a user with a topic refers to a condition wherein a user is participating in a topic. A user participating in a topic enjoys certain privileges with regard to the topic, such as eligibility to provide recommendations, receive recommendations, and indicate concurrence of opinion on recommendations provided within the context of such topic. Additionally, when a user associated with a topic indicates concurrence of opinion on an item, the system maintains relationships between the associated user and any other similarly associated users who have indicated concurrence of opinion on the same item within the same topic.

Further referring to FIG. 2, ITEMS data 204 describe a person, object, place, idea, event, or other entity which could be recommended as information of interest. In the disclosed embodiment of the present invention, ITEMS data 204 include a unique identifier (ID) for each item, and a reference hyperlink (URL) to a web page which represents a person, object, place, idea, event, or other entity. TOPIC_ITEMS data 205 describe an association of items with topics. In the disclosed embodiment of the present invention, an association of an item with a topic represents a condition wherein at least one user has recommended the associated item to participants in a topic. Such an associated item is considered a recommendation for a topic. In the disclosed embodiment of the present invention, TOPIC_ITEMS data 205 contain at least a unique identifier (TOPICS_ID) for an associated topic and a unique identifier (ITEMS_ID) for an associated item.

Still referring to FIG. 2, ITEM_RATINGS data 206 describe a rating that a user has given to an item recommended for a topic. In the disclosed embodiment of the present invention, a rating is a numerical value indicating a user's concurrence of opinion on whether an item is an appropriate recommendation for a topic, with a greater value indicating greater concurrence. In other embodiments, a rating can be a plurality of values, indicating for example concurrence of opinion on whether an item is an appropriate recommendation for a topic for a particular time period, or with a particular level of confidence. In the disclosed embodiment of the present invention, ITEM_RATINGS data 206 contain a value for a rating (RATING), and unique identifiers for a topic (TOPICS_ID), an item (ITEMS_ID), and a user (USERS_ID).

Further referring to FIG. 2, RELATIONSHIPS data 207 describe an association of a first user with a second user. In the disclosed embodiment of the present invention, relationships data contain, for a relationship from a first user (USER_ID_1) to a second user (USER_ID_2), a relationship value (VALUE). A relationship value is a measure of the extent of the first user's relationship with the second user, and is the level of trust that the first user has in recommendations made by the second user, with a greater relationship value indicating greater trust. Relationships are not bi-directionally equivalent. That is, a first user may trust recommendations provided by a second user more or less than the second user trusts recommendations provided by the first user. In other embodiments, a relationship may be characterized by a vector having multiple values, each value representing a unique characteristic of a relationship in addition to the level of trust a first user has in recommendations provided by a second user. In other embodiments, a relationship value may contain a plurality of measures of the level of trust a first user has in recommendations provided to a second user along with conditions under which such measures are valid, such as within the context of a particular topic or group of topics, or during certain periods of time.

Further referring to FIG. 2, RATING_CORRELATIONS data 208 describe the extent to which a relationship between two users is affected by two such users' ratings of the same recommendation. Referring to the example data, a RATINGS_CORRELATION 208 data element corresponding to a first rating (RATING_1) having a rating value of 1 and a second rating (RATING_2) having a rating value of 5, has a ratings correlation value (VALUE) of −10. Such an example ratings correlation value indicates that if a first user has rated a recommendation in a topic with a rating value of 1, and a second user rates the recommendation in the topic with a rating value of 5, then the relationship value of the relationship from the first user to the second user will be modified by −10. In the disclosed embodiment of the present invention, the more highly correlated two ratings are, the greater the corresponding ratings correlation value.

Further referring to FIG. 2, INVITATIONS data 209 describe an offering from a first user for a second user to participate in a topic. INVITATIONS data 209 include a unique identifier (INVITATIONS_ID) for each invitation, a unique identifier for the first user (INVITER_USERS_ID), a unique identifier for the second user (INVITEE_USERS_ID), and a unique identifier for the topic (TOPICS_ID). An invitation may include further data elements, such as a message from a first user to a second user and a status of the invitation. Such additional data elements are omitted for the sake of clarity, but would be obvious to one skilled in the relevant art(s).

### Operation—FIGS. 3-8

FIG. 3 is a simplified flowchart describing typical actions a user of the system may perform while interacting with the preferred embodiment of the present invention. At 301, the system enables a potential user to register as a user and login. At 302, the system retrieves relevant user, topic, and relationship information from a database. At 303, the system displays relevant user, topic and relationship information in a format readable by a user or by a machine for further processing. At 304, the system determines whether there is an invitation for a user to join a topic. At 305, the system enables a user to respond to an invitation, for example by displaying a hyperlink which, when selected, executes a process to enable a user to respond to an invitation, as further described in FIG. 4.

Further referring to FIG. 3, at 306, the system determines whether a user wants to view or modify an existing topic, for example by displaying a list of topics in which a user is a participant, each with a hyperlink which, when selected, executes a process to enable a user to view or modify an existing topic. At 307, the system enables a user to view or modify an existing topic, as further described in FIG. 5. At 308, the system determines whether a user wants to request recommendations, for example by displaying a hyperlink which, when selected, executes a process to enable a user to request recommendations. At 309, the system enables a user to request recommendations, as further described in FIG. 7. At 310, the system determines whether a first user wants to manage a relationship, for example by displaying a list of users, not including the first user, with whom the first user has a relationship, each such related user displayed with a hyperlink which, when selected, executes a process to enable a first user to manage the relationship with the related user indicated by the selected hyperlink. At 311, the system enables a user to manage a relationship, as further described in FIG. 8.

Further referring to FIG. 3, at 312, the system determines whether a user wants to manage preferences, for example by displaying a hyperlink which, when selected, enables a user to manage preferences. At 313, the system enables a user to manage preferences for example by displaying a form on a web page with current preference values, fields for new preference values, and a button which, when selected, updates preference information in a database with new preference values. Preferences may include, for example, a minimum relationship value to include a second user as a default recipient for a new topic invitation from a first user, whether a user accepts messages from related users, how frequently and under what conditions a user receives topic invitations and recommendations, and other preferences. At 314, the system determines whether a user wants to exit, for example by displaying a hyperlink allowing a user to exit, which, when selected, terminates further processing by the system for a user.

FIG. 4 is a flowchart describing a process to enable a user to respond to an invitation to join a topic from a second user, such second user referred to as an inviter. At 401, the system retrieves invitation information from a database. At 402, the system displays relevant invitation information in a format readable by a user or a machine. At 403, the system determines whether a user wants to join a topic referred to in an invitation, for example by displaying a hyperlink which, when selected, executes a process to enable a user to join the topic. At 404, the system registers a user as a participant in a topic in a database.

Further referring to FIG. 4, at 405, the system determines whether a user wants to communicate with an inviter, for example by displaying a hyperlink which, when selected, enables a user to communicate with an inviter. At 406, the system enables a user to communicate with an inviter by, for example, displaying a form on a web page with a field allowing a user to enter a message along with a button which, when selected, registers a message in a database for communication to an inviter. At 407, the system transmits a message to an inviter, for example by sending an email message to an inviter. At 408, the system records, in a database, an invitation having been completed, so that an invitation is not processed more than once, and communicates such record to the inviter.

FIG. 5 is a flowchart describing a process to enable a user to view or modify an existing topic. At 501 the system retrieves relevant topic, item, and rating information from a database. At 502, the system displays topic, item, and rating information in a format readable by a user or by a machine for further processing. At 503, the system determines whether a user wants to recommend a item, not previously recommended, for a topic, such recommended item referred to as a new recommendation, for example by displaying a hyperlink which, when selected, enables a user to add a new recommendation for a topic. At 504, the system enables a user to add a new recommendation to a topic, for example by displaying a form on a web page with a field enabling a user to enter a URL, and a button which, when selected, causes the system to determine whether an item referred to by the entered URL exists in a database, registers such item in the database if such item does not already exist in the database, and associates such new or existing item with the topic as a new recommendation. Step 504 may be followed by a user in response to a request for recommendations or spontaneously upon the occurrence of an event which a user deems of interest to one or more second users. Subsequent to step 504, other topic participants are able to view and rate the new recommendation.

Further referring to FIG. 5, at 505, the system determines whether a user wants to view or rate an existing recommendation, for example by displaying a hyperlink which, when selected, enables a user to view or rate an existing recommendation. At 506, the system enables a user to view or rate an existing recommendation, as further described in FIG. 6. At 507, the system determines whether a user wants to invite one or more users, not necessarily existing users of the system, to participate in a selected topic (i.e., to provide recommendations to other participants in the selected topic, to indicate concurrence of opinion on recommendations, and to receive recommendations from other participants in the selected topic), for example by displaying a hyperlink which, when selected, enables a user to invite participants to participate in a selected topic. At 508, the system enables a user to specify new participants, for example by displaying a form on a web page with a field where a user can enter one or more email addresses corresponding to individuals (not necessarily existing users of the system) whom the user would like to invite to participate in a topic, and a button which, when selected, registers entered email addresses in a database. At 509, the system creates new user accounts for participants who are not already registered as users within the system by registering new user information within a database. At 510, the system creates invitations to join a topic for new participants, registers such invitations in a database, and communicates such invitations to users by a variety of methods, possibly including sending email, sending electronic messages in another format, displaying invitation information during a user's next login to the system, and other methods.

FIG. 6 is a flowchart describing a process to enable a user to view a recommendation or to rate an existing item. At 601, the system retrieves item, rating, and relationship information from a database. At 602, the system displays item, rating, and relationship information in a format readable to the user or to a machine for further processing. Importantly, at 602 the system displays, for each rating provided by a source, a relationship value indicating the extent to which the user agrees with recommendations from the source, as an indicator of the level of trust the user should have in the rating. The system further displays, for each recommendation, a summary rating as an indication of the level of trust the user should have in the recommendation. When determining a summary rating for a recommendation for a user, the system appropriately takes into account the level of trust a user should have in each rating for the recommendation as well as the value of each rating for the recommendation. In determining a summary rating for a recommendation for a user, the system assigns greater emphasis to ratings provided by sources whose recommendations the user trusts more, and lesser emphasis to ratings provided by sources whose recommendations the user trusts less.

Further referring to FIG. 6, at 603, the system determines whether a user wants to add or update the user's own rating for an item, for example, by displaying a hyperlink on a web page which, when selected, enables a user to add or update the user's own rating for an item. At 604, the system enables a user to add or update the user's own rating for an item, for example by displaying a form on a web page with fields to allow a user to add a new rating or update the user's own existing rating for an item and a button which, when selected, registers the user's new or updated rating for an item in a database.

Further referring to FIG. 6, at 605, for a new or updated rating of a first item by a first user, the system determines correlation of the new or updated rating of the first item with other ratings provided by every other topic participant, not the first user, for the first item, by, for each such other rating: (1) determining a RATINGS_CORRELATION 208 data element having a first ratings correlation rating value (RATING_1) equal to the value of the new or updated rating (ITEM_RATINGS 206 data element RATING), and having a second ratings correlation rating value (RATING_2) equal to the value of the other rating (ITEM_RATINGS 206 data element RATING); (2) retrieving from a database the associated rating correlation value (RATING_CORRELATIONS data element 208 VALUE); and, in a similar manner, (3) repeating steps 1 and 2 for the new or updated rating of a first item by a first user and each subsequent other rating of the first item.

Further referring to FIG. 6, at 606, the system creates or updates, in data structure 207, for a first user who has provided a new or updated rating for an item in a topic, for each other topic participant, not the first user, who has also provided a rating for the item in the topic, a relationship between the first user and the other topic participant by adding the rating correlation value as determined in 605 to the current value of the relationship. Importantly, if no relationship exists between a first user who has provided a rating for a first item in a first topic and a topic participant, not the first user, who has provided a rating for the first item in the first topic, the system establishes a new relationship from the first user to the topic participant with a relationship value equal to the rating correlation value determined in 605. In this manner, the system establishes new relationships even when no such relationships could be determined from existing relationship information.

FIG. 7 is a flowchart describing a process to enable a user to request recommendations for a new topic. Importantly, the same process is followed for a user wishing to provide recommendations, not on request, to other users. At 701, the system enables a user to enter a new topic for recommendations, for example by displaying a form on a web page with a field for entering a name for a topic, and a button which, when selected, determines possibly related topics by, for example, searching a database of existing topics using as input the entered name. At 702, the system displays possibly related topics. At 703, the system determines whether an existing topic suffices for a user's request for new recommendations, for example by displaying a hyperlink on a web page for each existing topic which, when selected, enables a user to join the selected topic, and displaying another hyperlink which, when selected, creates a new topic in a database based on information entered in 701. At 704, the system enables a user to join an existing topic, for example by registering in a database an association of a user with a topic.

Further referring to FIG. 7, at 705, the system creates a new topic for a user, such user referred to as a topic creator, by registering new topic information, such as topic name, in a database. At 706, the system determines default proposed participants for a topic, for example by retrieving all users from a database with whom a topic creator has a relationship with a value greater than some threshold. At 707, the system enables a topic creator or a participant optionally to specify additional proposed participants for a topic, for example by displaying a form on a web page with a field to enter one or more email addresses, a field to enter a message, and a button which, when selected, registers a set of email address in a database for processing as additional participants for a topic. At 708, the system creates one or a plurality of new user accounts for additional proposed participants who are not registered users of the system. At 709, the system creates invitations to join a topic for default and additional proposed participants, registers such invitations in a database, and communicates an invitation to each proposed participant by a variety of methods, possibly including sending email, sending an electronic message in another format, displaying a message the next time a proposed participant accesses the system, and other methods. In alternative embodiments, the system automatically invites a first user to additional topics by determining for the first user a set of related users whose recommendations the first user trusts, determining a set of topics in which the related users are participants but in which the first user is not a participant, and inviting the first user to participate in such topics.

FIG. 8 is a flowchart describing a process to enable a user to manage a relationship. At 801, the system retrieves user and relationship information from a database. At 802, the system displays relationship information in a format readable by a user or by a machine for further processing. At 803, the system determines whether a first user wants to communicate with one or more other users with whom a first user has a relationship, such other users referred to as related users, for example by displaying a list of related users, each with a checkbox, and a button which, when selected, indicates that a first user wants to communicate with related user(s) whose associated checkbox is checked. At 804, the system enables a first user to communicate with one or more related users by, for example, displaying a form on a web page with a field to enter a personalized message along with a button which, when selected, registers a message in a database and transmits a message, along with an indicator of the relationship value between a first user and specified related user(s), to specified related user(s) through a variety of methods including, for example, sending an email, sending an electronic message in another format, displaying a message the next time related user(s) access the system, and other methods.

Further referring FIG. 8, at 805, the system determines whether a user wants to view a relationship value, for example by displaying a hyperlink associated with a relationship which, when selected, enables a user to view the value of a relationship corresponding to the associated hyperlink. At 806, the system enables a user to view a relationship value, for example by displaying a web page indicating the value of a relationship, in absolute terms, relative to other relationship values for the user, or in other ways, in a format readable by a user or by a machine for further processing. At 807, the system determines whether a user wants to modify a relationship value, for example by displaying a hyperlink associated with a relationship which, when selected, enables a user to modify the value of the selected relationship. At 808, the system enables a user to modify a relationship value, for example by displaying a form on a web page which comprises a current relationship value, a field to enter a new relationship value, and a button which, when selected, registers a new value for the relationship within a database.

### ADVANTAGES

From the description above, a number of advantages of the present invention are evident, including:
(a) The present invention provides a user with relevant, timely, comprehensive recommendations. The present invention comprises a convenient, practical means to determine which recommendations to trust. The present invention provides a user with recommendations from any domain, including domains outside the prior knowledge and experience of the user.
(b) The present invention provides an improved means to determine the level of trust a first user has in recommendations from a second user based on concurrence of opinion between the first user and the second user. Such means takes into account the relationship a first user recipient of recommendations has with a second user source of recommendations.
(c) The present invention provides a means to improve social interaction between a first and second user by presenting indications of the level of trust the first user has in recommendations from the second user contemporaneously with recommendations for the first user from the second user.
(d) The present invention provides recommendations in response to user requests as well as spontaneously upon the occurrence of an event of interest to a user.
(e) The present invention improves the quality and quantity of recommendations provided over time, and simultaneously improves the quality and quantity of a user's relationships with other users.
(f) The present invention discovers and establishes new relationships with other users, based upon concurrence of opinion. The present invention overcomes the problem of an overabundance of relationships with limited practical value.

### CONCLUSIONS, RAMIFICATIONS, AND SCOPE

Accordingly the reader will see that the recommendations provided by the present invention are relevant, timely, and comprehensive. Further, the disclosed method and process for identifying trusted information of interest has the additional advantages in that:
(a) A user can receive relevant, timely, comprehensive recommendations.
(b) A user can conveniently, practically determine which recommendations to trust.
(c) A user can receive recommendations from any domain, including domains outside the scope of the user's prior knowledge and experience.
(d) A user can determine the level of trust he should have in recommendations from another user, as well as verify and adjust the assumptions made in determining the level of trust.
(e) A user can have improved social interaction with other users by receiving recommendations from other users while, at the same time, understanding the level of trust she should have in those recommendations.
(f) A user can receive recommendations on request as well as spontaneously upon the occurrence of an event of interest to him.
(g) Over time, the user experiences improved quality and quantity of recommendations, and improved quality and quantity of relationships with other users.
(h) A user can discover and establish new relationships. A user is not burdened with an overabundance of relationships with limited practical value.

Although the description above contains many specificities, these specificities should not be construed as limiting the scope of the invention but merely as providing illustrations of some of the presently preferred embodiments of the present invention.

Thus the scope of the invention should be determined by the appended claims and their legal equivalents, rather than by the examples given.

I claim:

1. A method and process for identifying trusted information of interest, comprising:
(a) a means for managing eligibility of a user to recommend trusted information of interest, and
(b) a means for a user to recommend trusted information of interest, and
(c) a means to determine trust in recommended information of interest, whereby said method and process provides relevant, timely, comprehensive recommendations.

2. The method of claim 1 further comprising a means to present predicted level of trust in recommended information of interest to a user.

3. The method of claim 1 further comprising a means to present predicted level of trust in recommended information of interest to a user contemporaneously with a measure of trust among users.

4. The method of claim 1 wherein said means for managing eligibility of a user to recommend trusted information of interest comprises a means of determining the extent of a user's relationships with other users.

5. The method of claim 1 wherein said means for managing eligibility of a user to recommend trusted information of interest comprises at least one user-specific parameter.

6. The method of claim 1 wherein said means for a user to recommend trusted information of interest comprises a means for a user to indicate concurrence of opinion on recommended information of interest.

7. The method of claim 1 wherein said means to determine trust in recommended information of interest comprises a means for a user to set explicitly a measure of the ability of a first user to provide trusted information of interest to a second user.

8. The method of claim 1 wherein said means to determine trust in recommended information of interest comprises at least one user-specific parameter.

9. The method of claim 1 wherein said means to determine trust in recommended information of interest comprises a collaborative filter.

10. The method of claim 1 wherein said means to determine trust in recommended information of interest comprises a means of determining the extent of a user's relationships with other users

11. The method of claim 1 wherein the means to determine trust in recommended information of interest operates independently of degrees of separation of users in a social network.

12. The method of claim 1 wherein said means to determine trust in recommended information of interest comprises a means of determining levels of trust among users and at least one indication of concurrence of opinion on recommended information of interest.

13. The method of claim 1 further comprising a means to associate recommended information of interest with groupings of recommended information of interest.

14. The method of claim 1, further comprising a means for a user to express demand for recommendations of trusted information of interest.

15. The method of claim 1, further comprising a means for a user recipient of recommended information of interest to communicate with a user source of recommended information of interest.

16. A computer-implemented method for operating a machine to identify trusted information of interest, the method comprising the steps, performed by the machine, of
(a) managing eligibility of a user to recommend trusted information of interest, and
(b) enabling a user to recommend trusted information of interest, and
(c) determining trust in recommended information of interest.

17. The method of claim 16, further comprising the step of communicating trust in recommended information of interest to a user.
